(19) United States
(12) Patent Application Publication
(10) Pub. No.: US 2006/0008397 A1
(43) Pub. Date: Jan. 12, 2006

(54) Space-saving exhaust-gas aftertreatment unit with inflow and return-flow regions lying one inside the other and gas inlet and outlet on the same side

(75) Inventor: Rolf Bruck, Bergisch Gladbach (DE)

Correspondence Address: LERNER AND GREENBERG, PA, P O BOX 2480, HOLLYWOOD, FL, 33022-2480, US

(73) Assignee: Emitec Gesellschaft fur Emisionstechnologie MBH

(21) Appl. No.: 11/181,420

(22) Filed: Jul. 14, 2005

Related U.S. Application Data
(63) Continuation of application No. PCT/EP04/00085, filed on Jan. 9, 2005.

(30) Foreign Application Priority Data
Jan. 14, 2003 (DE) 103 01 138.2
Mar. 14, 2003 (DE) 103 11 236.7

(51) Int. Cl. B01D 53/34; F01N 3/28

(52) U.S. Cl. 422/180; 422/177

(57) ABSTRACT

An exhaust-gas aftertreatment unit includes first and second end faces and a honeycomb structure through which exhaust gas can flow. The honeycomb structure extends between the end faces in a tubular casing. A connector is at least substantially sealingly connected to the first end face for conducting the exhaust gas into an inflow region of the honeycomb structure. The exhaust gas can flow back through a return-flow region of the honeycomb structure after it has been diverted behind the second end face. The exhaust-gas aftertreatment unit advantageously allows aftertreatment of exhaust gases even when there is only a small amount of installation space available. This allows a blind space which is present in a side region of a turbocharger to be used to particularly good effect. The exhaust-gas aftertreatment unit can be produced at low cost and is reliable under fluctuating thermal loads, so that a good durability is achieved.

### CROSS-REFERENCE TO RELATED APPLICATION

This is a continuing application, under 35 U.S.C. § 120, of copending International Application No. PCT/EP2004/000085, filed Jan. 9, 2004, which designated the United States; this application also claims the priority, under 35 U.S.C. § 119, of German Patent Applications 103 01 138.2, filed Jan. 14, 2003 and 103 11 236.7, filed Mar. 14, 2003; the prior applications are herewith incorporated by reference in their entirety.

### BACKGROUND OF THE INVENTION

Field of the Invention

The invention relates to an exhaust-gas aftertreatment unit having a honeycomb structure and a connector.

Given the increasing numbers of automobiles being registered throughout the world, statutory exhaust restrictions which have to be satisfied by the composition of the exhaust gas emitted by the automobiles have been introduced in many countries in order to reduce air pollution caused by automobiles. The abatement in the emission levels of harmful constituents which is required to that end is brought about by the use of precious metal catalysts, which allow good conversion rates to be achieved at relatively low conversion temperatures. Effective conversion is also based on maximizing the size of the reaction surface area which is to be provided. In the automotive industry, it had become general practice to use honeycomb bodies as catalyst carrier bodies. Honeycomb bodies have a large number of cavities, such as for example passages, onto or through which a fluid can flow and which can be formed as a ceramic monolith or as a metallic structure.

A distinction is drawn primarily between two typical forms of metallic honeycomb bodies. An early form, typical examples of which are shown in German Published, Non-Prosecuted Patent Application DE 29 02 779 A1, corresponding to U.S. Pat. No. 4,273,681, is the helical form, in which substantially one smooth and one corrugated metal layer are placed on top of one another and wound up helically. In another form, the honeycomb body is constructed from a multiplicity of alternately disposed smooth and corrugated or differently corrugated metal sheets. The metal sheets initially form one or more stacks which are intertwined with one another. In that case, the ends of all of the metal sheets come to lie on the outside and can be connected to a housing or tubular casing, resulting in the formation of numerous joints which increase the durability of the honeycomb body. Typical examples of those forms are described in European Patent EP 0 245 737 B1, corresponding to U.S. Pat. Nos. 4,832,998, 4,803,189, 4,946,822 and 4,923,109 or International Publication No. WO 90/03220, corresponding to U.S. Pat. Nos. 5,105,539 and 5,139,844. It has also long been known to equip the metal sheets with additional structures in order to influence the flow and/or bring about cross-mixing between the individual flow passages. Typical examples of such configurations include International Publication No. WO 91/01178, corresponding to U.S. Pat. No. 5,403,559, International Publication No. WO 91/01807, corresponding to U.S. Pat. Nos. 5,045,403 and 5,130,208, and International Publication No. WO 90/08249, corresponding to U.S. Pat. No. 5,157,010. Finally, there are also honeycomb bodies in conical form, if appropriate also with further additional structures for influencing flow. A honeycomb body of that type has been described, for example, in International Publication No. WO 97/49905, corresponding to U.S. Pat. No. 6,190,784. Furthermore, it is also known to leave clear a recess in a honeycomb body for a sensor, in particular in order to accommodate a lambda sensor. One example is described in German Utility Model 88 16 154 U1.

Honeycomb bodies of that type are often used in an exhaust section, in which case they have two end faces and the exhaust gas flows into the honeycomb body through one end face and out of the honeycomb body through the other end face. If only a very small amount of space is available for installation of the honeycomb body, but at the same time the body is to be installed close to the engine, it is expedient to use a honeycomb body in which the exhaust gas flows into and out of the honeycomb body through a single end face. In that case, therefore, two separate flow regions are formed inside the honeycomb body. A honeycomb body with two concentric flow regions for use in multiple exhaust systems in which exhaust gas flows through the regions alternately in the same direction, i.e. in the same direction of flow, is known, for example, from U.S. Pat. No. 6,156,278. Those flow regions are separated by a tube located between the regions. A honeycomb body of that type is very complex to produce, and moreover the additional tube impairs the thermal properties of the honeycomb body, such as heating-up and heat dissipation characteristics. It is known in turn from European Patent EP 0 835 366 B1, corresponding to U.S. Pat. No. 5,976,473, to provide a honeycomb body with at least one planar partition which is disposed in a substantially sealing manner at the end side and thereby to provide a honeycomb body having two subregions which are semicircular in cross section for use in multiple exhaust systems.

### SUMMARY OF THE INVENTION

It is accordingly an object of the invention to provide a space-saving exhaust-gas aftertreatment unit with inflow and return-flow regions lying one inside the other and gas inlet and outlet on the same side, which overcomes the hereinafore-mentioned disadvantages of the heretofore-known devices of this general type, is simple to produce, can be produced at low cost and has a good durability under fluctuating thermal loads, yet nevertheless can be disposed in a space-saving manner under unfavorable spatial conditions.

With the foregoing and other objects in view there is provided, in accordance with the invention, an exhaust-gas aftertreatment unit, comprising a first end face, a second end face, a tubular casing and a honeycomb structure through which the exhaust gas can flow. The honeycomb structure is extended between the first end face and the second end face in the tubular casing. The honeycomb structure has an inflow region and a return-flow region. A connector through which the exhaust gas can flow into the inflow region is at least substantially sealingly connected to the first end face. A flow-inverter behind the second end face diverts the exhaust gas from the inflow region into the return-flow region.

In accordance with another feature of the invention, the exhaust-gas aftertreatment unit of this type can advantageously be used where the space available is small. The exhaust gas which is to be treated flows both into and out of the honeycomb structure through the first end face.

In accordance with a further feature of the invention, the connector is constructed in such a way that the inflow region and the return-flow region are disposed concentrically or eccentrically. Depending on the spatial and thermal requirements, the inflow region may lie on the inside or outside. The inflow region preferably lies on the inside.

In accordance with an added feature of the invention, if it is desired to achieve a lower temperature in the return-flow region than in the inflow region, for example because the return-flow region is coated with an adsorber or storage material, the flow-inverter should not be thermally insulated. Otherwise, thermal insulation is advantageous.

The first end face may preferably have a substantially homogeneous structure, so that in particular substantially regular admission openings are formed as access to the cavities of the honeycomb structure but there are no additional reinforced partitions passing through the honeycomb structure. This makes it possible to dispense with additional reinforced partitions or separating measures, such as for example a tube separating the two regions, so that the honeycomb structure can be formed at low cost. By way of example, it is possible to use a standard honeycomb structure made from ceramic or metal when constructing the exhaust-gas aftertreatment unit according to the invention. However, the term homogeneous does not necessarily mean that all the passages have to be of the same shape and/or size.

A substantially standardized honeycomb structure can be used in an exhaust-gas aftertreatment unit according to the invention, and in particular there is no need to form an inner tube separating the inflow and return-flow regions, which means that the exhaust-gas aftertreatment unit can be produced in a simple way and at low cost. The inflow and return-flow regions are separated from one another by walls of the cavities of the honeycomb structure, as predetermined by the connector. An at least substantially sealing connection of the connector to the first end face of the honeycomb structure is achieved by virtue, for example, of the first end face having a slot, the spatial size of which is selected to correspond to the spatial size of the connector. The fact that the connector projects into the slot in the form of a labyrinth seal in the end face of the honeycomb structure advantageously increases the sealing of the partition with respect to the honeycomb body even in the event of fluctuating thermal loads without there being any possibility of the honeycomb structure being damaged in the event of relative expansions on the part of the connector.

Minor leaks, which may be caused, for example, by the connector intersecting a cavity wall at an angle, i.e. small quantities of exhaust gas flowing into what is actually the return-flow region rather than into the inflow region, are irrelevant due to the pressure and flow conditions in the honeycomb structure.

In accordance with an additional feature of the invention, the first end face has a slot, into which the connector projects in a substantially sealing manner, preferably so as to form a sliding or slip seat.

The fact that a sliding or slip seat is formed makes it possible to configure the exhaust-gas aftertreatment unit in such a way that different thermal expansion characteristics on the part of the components, in particular the honeycomb structure, do not cause damage to the exhaust-gas aftertreatment unit. The formation of a sliding or slip seat on one hand means that no forces are introduced from the honeycomb structure to the connector and on the other hand no forces are introduced from the connector into the honeycomb structure.

In accordance with yet another feature of the invention, the connector is pressed into the first end face. This makes it possible, in an advantageously simple way, both to form a slot in the first end face and to produce a connection between the connector and the first end face. A connection of this nature is substantially gas-tight. Minor leaks are of little importance due to the pressure and flow conditions in the inflow and return-flow regions while the exhaust-gas aftertreatment unit is operating.

In accordance with yet a further feature of the invention, the connector bears substantially against the first end face. This provides a further advantageous way of producing a connection between the connector and the first end face which is simple and inexpensive to produce.

In accordance with yet an added feature of the invention, a first seal is formed between the connector and the first end face. The first seal is advantageously constructed to be able to withstand high temperatures and to be resistant to corrosion, for example in the form of a sealing ring which bears in a sealing manner between the edge of the connector and the first end face.

In accordance with yet an additional feature of the invention, the connector is constructed as a conically widening tube. Forming the connector as a conically widening tube makes it possible, in a simple way, to construct an exhaust-gas aftertreatment unit according to the invention. In this case, the connector is guided centrally through a discharge. The discharge is used to discharge the exhaust gas flowing through the return-flow region and may be constructed substantially in the form of a spherical cap, as seen in cross section, in which case the discharge must at one location allow the exhaust gas to be discharged from the exhaust-gas aftertreatment unit, for example by forming a flange for connection of a pipe or the like. In this case, the conically widening tube passes through the discharge, which is in the form of a spherical cap. In this case too, it is preferably ensured that any thermally induced movement of the conically widening pipe and/or of the discharge in the form of a spherical cap, does not cause any damage to the other component in each case.

In accordance with again another feature of the invention, the honeycomb structure is constructed from ceramic material. However, it is also possible for the honeycomb structure to be constructed from metallic material. In this context, it is particularly preferred for the honeycomb structure to be built up by winding up at least one metallic layer, which is at least partially structured, or a plurality of metallic layers, at least some of which are at least partially structured, or by the honeycomb structure being built up by stacking and intertwining a plurality of metallic layers, at least some of which are at least partially structured. In the context of the present invention, the term metallic layer is to be understood as meaning not only a sheet-metal layer but also a combination of a sheet-metal layer with a material which at least partially allows a fluid to flow through it, and also a layer of a material which at least partially allows a fluid to flow through it. Layers of this type can be combined with one another in any desired way to construct a honeycomb structure.

In accordance with again a further feature of the invention, it is possible to construct helical honeycomb structures, and it is also possible to construct honeycomb bodies by intertwining a plurality of stacks, for example in an S shape, or to intertwine three stacks in the same direction. Constructing the honeycomb body from structured metallic layers with a structure repetition length which, for example in the case of corrugated metallic layers, corresponds to the wavelength, and substantially smooth metallic layers, leads to the formation of passages or cavities between the structures and the smooth metal sheets.

In accordance with again an added feature of the invention, at least in some of the metallic layers, holes are formed in at least some of the regions which form the walls of the cavities of the inflow region and/or of the return-flow region. These holes in particular have a size which is larger than the structure repetition length of the at least partially structured metallic layers.

In this case, the holes may be formed both in the substantially smooth metallic layers and in the structured metallic layers. This makes it possible to form cavities which swirl up the exhaust gas, advantageously leading to an improved conversion rate. Moreover, the formation of holes reduces the production costs of the honeycomb structure, in particular also with regard to the coating of the honeycomb structure.

In accordance with again an additional feature of the invention, at least some of the metallic layers, in at least some of the regions which form the walls of the cavities of the inflow region and/or of the return-flow region, are formed from a material which at least partially allows a fluid to flow through it.

This advantageously makes it possible to construct an open particulate filter. A particulate filter is referred to as open if in principle particulates can pass all the way through it, specifically even particulates which are considerably larger than the particulates which are actually to be filtered out. As a result, a filter of this type cannot become blocked during operation even in the event of particulates agglomerating. A suitable method for measuring the openness of a particulate filter is, for example, to test the diameter up to which spherical particulates can still pass through a filter of this type. For current applications, a filter is open in particular if spheres with a diameter of greater than or equal to 0.1 mm can still pass through it, preferably spheres with a diameter of over 0.2 mm.

As this material is flowing through, the particulates accumulate in the wall, with the flow through the wall being promoted by the formation of pressure differences in front of and behind the wall. These pressure differences are caused and/or delayed by the formation of scoops and/or flow-guiding surfaces in the metallic layers which are not formed from a material which is at least partially permeable to a fluid. The scoops and/or flow-guiding surfaces are formed only in those regions of the metallic layer which subsequently form the walls of the cavities in the inflow region and/or in the return-flow region. The substantially smooth metallic layers and/or the at least partially structured metallic layers may be formed at least in part from the material which is at least partially permeable to a fluid. Constructing an exhaust-gas aftertreatment unit according to the invention as a particulate filter advantageously makes it possible to construct space-saving particulate filters.

In accordance with still another feature of the invention, at least in some of the metallic layers, scoops, holes having a size which is smaller than the structure repetition length of the at least partially structured metallic layers, flow-guiding surfaces and/or microstructures are formed in at least some of the regions which form the walls of the cavities of the inflow region and/or of the return-flow region.

The term scoop represents a hole with protuberances, the dimensions of the hole being smaller than the structure repetition length of the structures belonging to the at least partially structured metallic layers. The protuberance forms a flow-guiding surface. The interaction between holes and flow-guiding surfaces leads to the formation of transversely running flow components, so that the flow is swirled up and also flows between adjacent cavities. Swirling up the flow advantageously prevents the formation of laminar boundary flows and therefore leads to an increased conversion rate. The same purpose is also served by microstructures which have a structure height that is significantly smaller than the structure height of the at least partially structured metallic layers. Scoops, holes, flow-guiding surfaces and microstructures may be formed both on and in the substantially smooth metallic layers and on or in the at least partially structured metallic layers. The scoops, flow-guiding surfaces and microstructures can be formed at any desired angle with respect to the main direction of flow of the exhaust gas in the honeycomb structure.

In accordance with still a further feature of the invention, at least some of the metallic layers are provided with a coating, preferably a catalytically active coating, in at least some of the regions which form the walls of the cavities of the inflow region and/or of the return-flow region.

In accordance with still an added feature of the invention, it is possible for at least some of the metallic layers to be provided with a coating, in particular a catalytically active coating, both in the regions which form the walls of the cavities of the inflow region and in the regions which form the walls of the return-flow region. For example, it is possible to form inflow regions and return-flow regions which are both provided with a catalytically active coating. It is equally possible for the walls of the cavities of the inflow region to be provided with an oxidation catalyst coating and for the walls of the cavities of the return-flow region to be formed from material which is at least partially permeable to a fluid, in order to obtain a compact combined oxidation catalytic converter/particulate filter in this way. The nitrogen dioxide (NO₂) formed in the region of the oxidation catalytic converter in this case is advantageously used to continuously regenerate the particulate filter region.

In accordance with still an additional feature of the invention, the walls of the inflow region and/or of the return-flow region have a coating at least in partial regions.

In this case, the subregions may be formed in the direction of flow, i.e. the inflow region or the return-flow region have regions with or without a coating in the corresponding directions of flow through these regions. Furthermore, a coating may also be formed in subregions, by way of example, in a direction which is perpendicular to the respective directions of flow through these regions. For example, the inner region of the inflow region may be constructed with a coating, while other regions, for example those outside the inner region, do not have a coating or have a different coating. The term walls of the inflow and/or return-flow region is to be understood as meaning the walls of the cavities or passages in these regions. The coating may be formed of washcoat or may include washcoat.

In accordance with another feature of the invention, the coating, at least in an inflow direction and/or in a return-flow direction, is inhomogeneous, in particular with regard to the presence of a coating, to the type of coating and/or with regard to different physical and/or chemical effects which are initiated at, in and/or on the coating.

The inflow direction is the direction of flow in which exhaust gas can flow through the inflow region, while the return-flow direction is the direction of flow in which exhaust gas can flow through the return-flow region. These are overall parameters relating to the flow through the honeycomb structure. Other directions of flow may occur locally both in the inflow region and in the return-flow region.

In this context, the term inhomogeneous means in particular that the coating of the walls of the inflow region and/or of the return-flow region in each case changes in the direction of flow. By way of example, a subregion may have a coating while another subregion does not have a coating. Furthermore, it is possible to form different types of coatings. The abovementioned physical and/or chemical effects which are brought about at, in and/or on the coating may be caused not only by the coating itself but also by particles embedded in the coating. For example, it is possible to form subregions which catalyze chemical reactions, for example through the use of incorporated precious-metal catalysts which at least at certain times adsorb one or more components of the exhaust gas and at other times, for example at different temperatures, desorb these components again, and the like. These physical and/or chemical effects may take place both at the coating, i.e. for example in the upper region of the coating, in the coating, for example promoted by using a type of coating which is porous or greatly increases the surface area, and/or on the coating, i.e. on the surface of the coating.

It is particularly advantageous for the honeycomb structure as a whole to be formed with two coatings as far as a boundary surface. This can be achieved in particular by the honeycomb structure, after it has been produced, being dipped from one end face into a bath containing a first coating agent, then being pulled out and dipped from the other end face into a bath holding a second coating agent. When a honeycomb structure which has been coated in this way is used in an exhaust-gas aftertreatment unit according to the invention, the exhaust gas first of all flows through a region having the first coating then, while it is still in the inflow region, flows through a region having the second coating. After it has been diverted at the flow-inverter, the exhaust gas in the return-flow region first of all flows through a region having the second coating and then a region having the first coating. It is particularly advantageous for the first coating to be constructed as a three-way catalyst coating and for the second coating to be constructed as an HC adsorber coating, i.e. as a coating which at least from time to time adsorbs hydrocarbons, or vice-versa. Furthermore, it is advantageous to divert the exhaust gas twice, in which case the exhaust gas flows out of the exhaust-gas aftertreatment unit in the same direction as it flows into it. For this purpose, a first flow-inverter is formed at the second end face. The external diameter of the first flow-inverter does not correspond to the external diameter of the second end face, but rather is smaller than the external diameter of the second end face. A second flow-inverter, which diverts the exhaust gas once again, is formed at the first end face, outside the inflow region. This can advantageously be combined with an inhomogeneous coating and also with an inflow region in the interior of the honeycomb structure, which represents a single cavity through which a fluid can flow.

In accordance with a further feature of the invention, the inflow region and/or the return-flow region, at least in one of a plurality of axial subregions, has at least one of the following coatings:
a) oxidation catalyst coating;
b) three-way catalyst coating;
c) adsorber coating;
d) nitrogen oxide adsorber coating;
e) hydrocarbon adsorber coating; and
f) selective catalytic reduction coating.

It is possible for exhaust-gas aftertreatment units to be used for a very wide range of application areas, depending on the type of coating a) to f) and also depending on the combination of coatings a) to f). In particular, it is possible in this way to form exhaust-gas aftertreatment units having a plurality of subregions through which exhaust gas can flow in succession, each of these subregions having at least one of the coatings a) to f).

In accordance with an added feature of the invention, those regions of the metallic layers which form the walls of the cavities of the inflow region have a first specific heat capacity, and those regions which form the walls of the cavities of the return-flow region have a second specific heat capacity. The first specific heat capacity is different than the second specific heat capacity, in at least some of the metallic layers.

This makes it possible to construct honeycomb structures in which the inflow region has a different specific heat capacity than the return-flow region. In this way it is possible, for example, to produce a honeycomb structure which has a reduced specific heat capacity in the inflow region or alternatively only in parts of the inflow region, in order in this way to allow this region to be heated up more quickly and therefore to enable catalytic conversion light-off to be achieved more quickly.

In accordance with an additional feature of the invention, in at least some of the metallic layers the regions which form the walls of the cavities of the inflow region differ from the regions which form the walls of the cavities of the return-flow region with regard to at least one of the following properties:
A) material thickness;
B) configuration, size and thickness of a reinforcing structure; and
C) configuration and composition of a coating.

Each of the possible options A, B and C, individually or in combination with one another, advantageously makes it possible to form honeycomb bodies in which the first specific heat capacity of the inflow region differs from the second specific heat capacity of the return-flow region. A greater specific heat capacity in the return-flow region can be achieved, for example, by increasing the thickness of the material in the corresponding region of the metallic layers, in particular of the metal sheets, for example by folding over the edges of the metallic layers. A corresponding effect can also be achieved by forming reinforcing structures, which may include, for example, an additional layer of material joined to the metallic layer, in some of the regions. With all of the procedures which can be used to alter the thickness of the layer at least in regions, it is also possible to modify the structuring of the structured metallic layer accordingly, so that a continuous bearing surface with respect to an adjacent metallic layer is advantageously formed, so that a good connection to this adjacent metallic layer can be formed. The specific heat capacity of the regions of the metallic layers can also be altered by the application of coatings. For example, it is possible for a coating to be applied in one region of the metallic layer while another region does not have a coating or has a different coating.

In accordance with still another feature of the invention, the regions of the metallic layer which form the walls of the cavities of the inflow region and/or of the return-flow region have an inhomogeneous specific heat capacity.

By way of example, the specific heat capacity of the subregion of the inflow region through which exhaust gas flows first may be lower than the specific heat capacity of the remainder of the inflow region, in order to allow catalytic conversion light-off to be achieved more rapidly.

In accordance with still a further feature of the invention, the regions of the structured metallic layers which form the walls of the inflow region have a structuring with a first structure repetition length, a first structure height and a first structure shape, and the regions which form the walls of the return-flow region have a structuring with a second structure repetition length, a second structure height and a second structure shape. The first structure repetition length differs from the second structure repetition length and/or the first structure height differs from the second structure height and/or the first structure shape differs from the second structure shape.

This advantageously makes it possible to construct honeycomb structures with cell densities and/or shapes which differ in the inflow region and return-flow region or honeycomb structures in which the inflow region and/or the return-flow region has subregions of differing cell densities and/or shapes. Any desired combination of the abovementioned configurations of the regions of the metallic layers which form the walls of the inflow region and/or return-flow region are also possible and in accordance with the invention.

In accordance with still an added feature of the invention, a flow-inverter, which inverts the direction of flow of the exhaust gas flowing out of the inflow region in such a way that it flows into the return-flow region, is disposed behind the second end face of the honeycomb structure. In this context, it is particularly preferable for the flow-inverter to be constructed substantially in half-shell form, in particular as hemispheres with an indentation in the center.

In accordance with still an additional feature of the invention, the flow-inverter is constructed substantially in half-shell form, in particular substantially as hemispheres, substantially as half a spherical cap or substantially as a cylinder which is closed on one side, if appropriate in each case with an indentation in the center. The use of a flow-inverter in half-shell form is advantageous, since it can then be of simple and inexpensive configuration. Constructing the flow-inverter in the form of a cylinder which is closed on one side, when seen in longitudinal section, represents a rectangle which is open on one side.

In accordance with again another feature of the invention, a collection space, in which the exhaust gas flowing through the return-flow region and exhaust gas emerging through the first end face outside the connector are collected, is formed at the first end face.

The term “outside the connector” is to be understood in the present context in the sense of “with the exception of at the connector”, since the connector may also lie outside the collection space, for example if the inflow region is formed concentrically outside the return-flow region.

In accordance with again a further feature of the invention, the collection space is formed substantially as a spherical cap, as a hemisphere or in the form of a closed half-cylinder. These forms or shapes are simple to produce and are eminently suitable for the absorption of thermal stresses.

In accordance with again an added feature of the invention, an outflow, through which the exhaust gas flowing through the return-flow region can be discharged, is connected to the collection space and/or the tubular casing.

In the case where the outflow, which may be constructed as a simple tube or as a flange with a corresponding connector for connection to the tubular casing and/or to the collection space, is connected to the tubular casing, the latter may at any desired location have a widening which allows the exhaust gas to flow from the collection space through this widening to the outflow. A configuration where the outflow is connected to the collection space can be implemented in a particularly simple way by the outflow being connected in a substantially gas-tight manner to a corresponding recess in the collection space, for example by welding. In particular, it is also possible and in accordance with the invention for the collection space and/or the outflow to be constructed as a casting. The collection space and outflow can advantageously have an integral or one-piece construction.

In accordance with again an additional feature of the invention, the outflow is connected in a gas-tight manner to the tubular casing and/or the collection space and/or the collection space is connected in a gas-tight manner to the tubular casing.

In accordance with yet another feature of the invention, the connector passes through the collection space or the outflow passes through the connector, in each case in a passage region.

In accordance with yet a further feature of the invention, a thermally joined connection between the connector and the collection space or between the outflow and the connector, preferably a brazed or welded joint, particularly preferably a welded joint, is formed in the passage region.

The formation of a thermally joined connection advantageously allows this connection to absorb holding forces.

In accordance with yet an added feature of the invention, a sliding or slip seat is formed in the passage region. A sliding or slip seat in the passage region particularly advantageously makes it possible to absorb holding forces with very good compensation for length expansions on the part of the components, in particular the honeycomb structure, in the event of fluctuating thermal loads.

In accordance with yet an additional feature of the invention, a second seal is formed in the passage region. In particular, the combination of the second seal, which is preferably able to withstand high temperatures and is corrosion-resistant, with a sliding or slip seat, combines good gas tightness with very good expansion compensation options.

In accordance with another feature of the invention, the collection space and/or the outflow is constructed to be more resistant to deformation than the tubular casing, in particular to have a greater material thickness than the latter.

The ability of the collection space and/or the outflow to resist deformation is greater than that of the tubular casing in particular with regard to deformation transversely with respect to the inflow or return-flow direction. Therefore, the exhaust-gas aftertreatment unit as a whole can advantageously be held solely by the collection space and/or the outflow, if appropriate with further bearing or support at the flow-inverter. This makes it possible to save costs when forming the tubular casing.

In accordance with a further feature of the invention, at least one measurement sensor is provided, in particular in the flow-inverter. Measurement sensors are used in particular for the on-line monitoring of the exhaust-gas aftertreatment unit in automotive engineering, for example in what is known as on-board diagnosis (OBD or OBD II).

In accordance with an added feature of the invention, the measurement sensor can record at least one of the following measurement variables:
a) oxygen content of the exhaust gas;
b) temperature of the exhaust gas;
c) level of at least one component of the exhaust gas;
d) flow velocity of the exhaust gas; and
e) volumetric flow density of the exhaust gas.

In particular, the determination of the oxygen content, especially through the use of a lambda sensor, and the determination of the temperature of the exhaust gas, are often required specifically for OBD. If the measurement sensor is provided in the honeycomb structure itself, it is generally necessary to accept a compromise with regard to the number of passages or cavities through which the measurement sensor passes. That is because on one hand the maximum possible number of cavities is desirable in order to obtain a measurement signal which has been taken as a mean over the maximum possible number of cavities and on the other hand the minimum possible number of cavities should be intersected by the measurement sensor, in order to ensure that only the minimum possible catalytically active surface area is lost if, for example, the honeycomb body is formed as a catalyst carrier body. In this context, providing the measurement sensor in the flow-inverter offers advantages, since the result is a measurement signal which is taken as a mean over all of the cavities of the inflow region without, for example, catalytic surface area being lost. In particular, the measurement sensor may be constructed as a lambda sensor and/or as a temperature sensor.

In accordance with an additional feature of the invention, at least one reagent-feed unit is provided, in particular in the flow-inverter. The provision of a reagent-feed unit, in particular for supplying reducing agent, such as urea, into the flow-inverter, saves space as compared to providing it in the honeycomb structure and it can be implemented at low cost.

In accordance with a concomitant feature of the invention, it is advantageous if the flow-inverter has a muffling, for example in the form of a coating or in the form of guide surfaces or the like. Furthermore, it is advantageous for the pressure loss suffered by the exhaust gas as it flows through the exhaust-gas aftertreatment unit to be substantially equal in the individual regions, such as the inflow region, the return-flow region, the flow-inverter and the collection space, if appropriate with the outflow.

Other features which are considered as characteristic for the invention are set forth in the appended claims.

Although the invention is illustrated and described herein as embodied in a space-saving exhaust-gas aftertreatment unit with inflow and return-flow regions lying one inside the other and gas inlet and outlet on the same side, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, longitudinal-sectional view of a first exemplary embodiment of an exhaust-gas aftertreatment unit according to the invention;

FIG. 2 is a partly-sectional, end-elevational view of a honeycomb structure of an exhaust-gas aftertreatment unit according to the invention;

FIG. 3 is a plan view of a metallic layer used to construct a honeycomb structure as shown in FIG. 2;

FIG. 4 is a fragmentary, perspective view of an example of a metallic layer with scoops;

FIG. 5 is a fragmentary, sectional view of an example of a passage with microstructures;

FIG. 6 is a longitudinal-sectional view of a second exemplary embodiment of an exhaust-gas aftertreatment unit according to the invention;

FIG. 7 is a longitudinal-sectional view of a third exemplary embodiment of an exhaust-gas aftertreatment unit according to the invention;

FIG. 8 is a longitudinal-sectional view of a fourth exemplary embodiment of an exhaust-gas aftertreatment unit according to the invention;

FIG. 9 is a longitudinal-sectional view of a fifth exemplary embodiment of an exhaust-gas aftertreatment unit according to the invention;

FIG. 10 is a longitudinal-sectional view of a sixth exemplary embodiment of an exhaust-gas aftertreatment unit according to the invention; and

FIG. 11 is a view similar to FIG. 1, but in which the inflow direction and the return-flow direction of the exhaust gas have been reversed.

### DESCRIPTION OF THE PREFERRED EMBODIMENTS

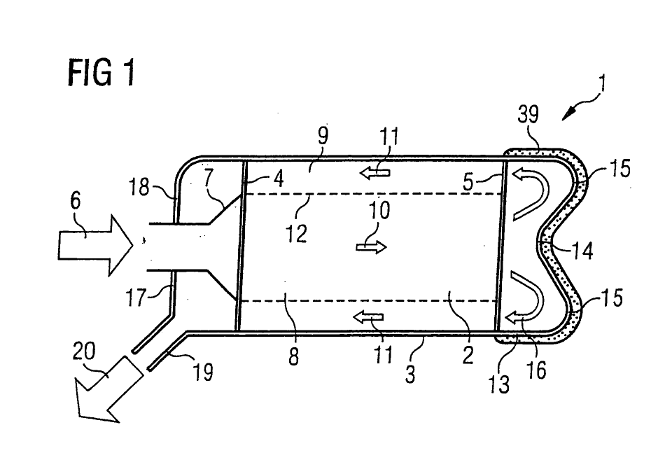

Referring now to the figures of the drawings in detail and first, particularly, to FIG. 1 thereof, there is seen a diagrammatic, longitudinal-sectional illustration through an exhaust-gas aftertreatment unit 1 which has a honeycomb structure 2 in a tubular casing 3. The honeycomb structure 2 has a first end face 4 and a second end face 5, between which cavities extend through which a fluid can flow and may preferably form passages. An exhaust-gas stream 6 which is to be treated flows through a connector 7, that is constructed in the form of a conically widening tube, into the honeycomb structure 2. The connector 7 is at least substantially sealingly connected to the first end face 4 by virtue of the latter having a slot into which the connector 7 engages at the end side. This substantially sealing connection is provided in a virtually or nearly or almost sealing manner. This connection is preferably constructed in the form of a substantially sealing sliding seat. For this purpose, it is also possible for a short piece of tube to be inserted into the slot. This piece of tube then forms a sliding seat together with the connector 7.

The flow directed toward the first end face 4 through the connector 7 leads to an inflow region 8 and a return-flow region 9 being formed. The inflow region 8 is located inside the return-flow region 9. In the inflow region 8, the exhaust gas flows substantially in an inflow direction 10, while in the return-flow region 10 it flows substantially in the opposite direction, a return-flow direction 11. The inflow region 8 and the return-flow region 9 are not separated from one another by any special structural measures, and in particular there is no intermediate tube which separates the inflow region 8 from the return-flow region 9. A separation 12 between the inflow region 8 and the return-flow region 9 includes walls of the cavities through which a fluid can flow and which lie in a region behind the connector 7. Consequently, the separation 12 between the inflow region 8 and the return-flow region 9 does not represent a separate component, but rather is to be understood in the sense described above.

Since there is substantially no need for any special measures to separate the inflow region 8 from the return-flow region 9, it is possible for a standard honeycomb structure made from ceramic or metallic layers, which if appropriate simply has to be provided with a slot in the first end face 4, to be used as the honeycomb structure 2.

The exhaust gas flowing through the inflow region 8 leaves the honeycomb structure 2 through the second end face 5 and flows into a flow-inverter 13. The flow-inverter 13 may be constructed in half-shell form and in the present case has an indentation 14 and two elevations 15. The indentation 14 is formed centrally in front of that region of the second end face 5 from which the exhaust gas flowing through the inflow region 8 emerges from the second end face 5.

Due to the shape of the flow-inverter 13, the direction of flow of the exhaust gas leaving the flow-inverter 13 is inverted as indicated by an arrow 16, and the exhaust gas then flows through the second end face 5 into the return-flow region 9 in the return-flow direction 11. The flow-inverter 13 is connected in a gas-tight manner to the tubular casing 3, for example by welding or brazing, in order to avoid undesired exhaust-gas losses. It may be provided with a thermal insulation 39 in order to avoid heat losses.

After the exhaust gas has flowed through the entire length of the honeycomb structure 2, the exhaust gas leaves the honeycomb structure 2 through the first end face 4 outside the connector 7 and enters a discharge 17, which includes a collection space or chamber 18 and an outflow 19 that branches off from the collection space or chamber 18. The outflow 19 may be constructed as a flange or as a tube. An exhaust-gas stream 20 which has been treated leaves the exhaust-gas aftertreatment unit 1 through the outflow 19. The discharge 17 is also connected in a sealing manner to the tubular casing 3, in order to avoid undesired emissions of exhaust gases.

In the present exemplary embodiment, the collection space or chamber 18 is constructed in the form of a spherical cap, surface or cup. The outflow 19 is constructed as a tube which is fitted to the spherical cap. The connector 7 passes through the collection space or chamber 18 which is in the form of the spherical cap. It is also possible for the collection space or chamber 18 to be constructed as a hemisphere or as a cylinder which is closed on one side.

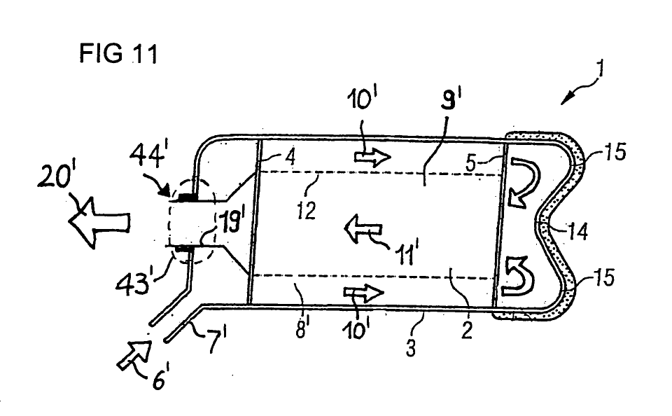

FIG. 11 is a view similar to FIG. 1, but in which the inflow direction and the return-flow direction of the exhaust gas have been reversed. Accordingly, an exhaust gas stream 6′ enters a connector 7′ and travels along the inflow direction 10′ in an inflow region 8′ to the flow inverter 13. The flow inverter 13 directs the exhaust gas into a return-flow region 9′ and along the return-flow direction 11′, from which an exhaust gas stream 20′ leaves an outflow 19′. In contrast to FIG. 1, in the FIG. 11 embodiment, the outflow 19′ passes through the connector 7′. Therefore, in this embodiment, the inflow region lies on the outside.

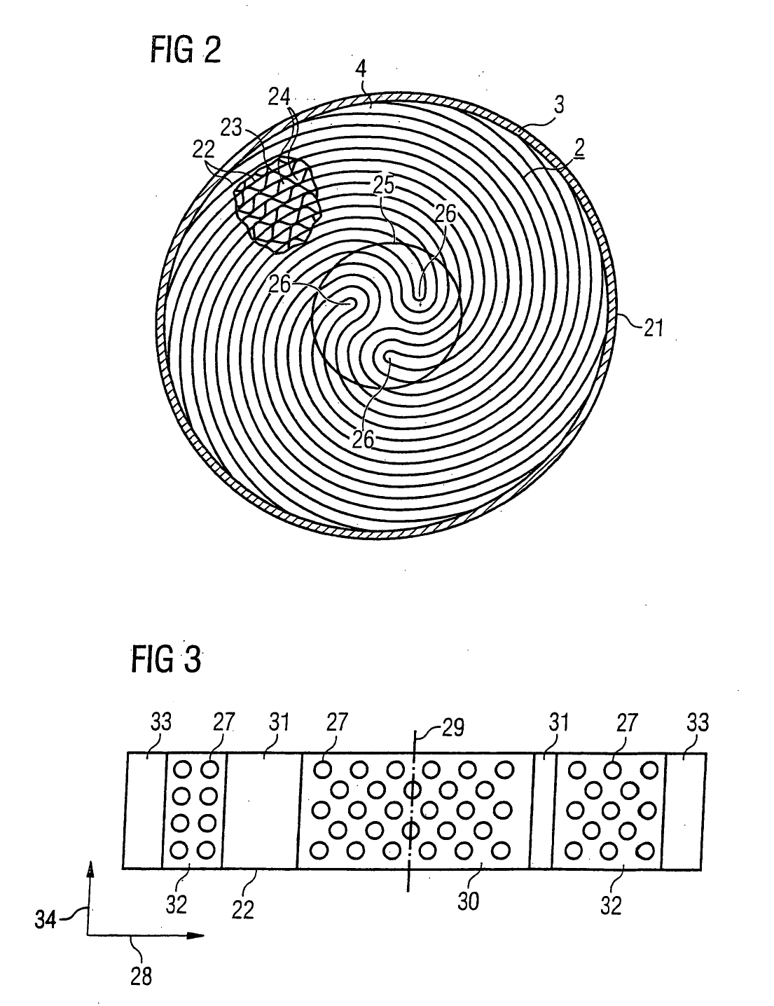

FIG. 2 shows an end-elevational view of a honeycomb body 21 of an exhaust-gas aftertreatment unit 1 according to the invention. The honeycomb body 21 includes a honeycomb structure 2 which is secured in a tubular casing 3. The honeycomb structure 2 is composed of substantially smooth metallic layers 22 and structured metallic layers 23, which form passages 24 through which a fluid can flow. The first end face 4 has a slot 25, into which the connector 7 engages. The position, shape, thickness and size of the slot 25 are therefore matched to the connector 7. The slot 25 and the connector 7 are constructed in such a way that the connector 7 is connected in an at least substantially sealing manner to the first end face 4 of the honeycomb structure 2, in particular in the form of a labyrinth seal.

The honeycomb structure 2 shown in FIG. 2 was formed by winding three stacks of metallic layers 22, 23 in the same direction. The individual stacks are formed by the alternating stacking of substantially smooth metallic layers 22 and structured metallic layers 23. Each stack is folded about a respective central point 26, and then the three stacks are fitted together and wound in the same direction.

FIG. 3 shows a metallic layer with holes 27 having dimensions which are larger than a structure repetition length of the structures of the structured metallic layers 23. If, by way of example, such holes 27 are to be formed in the cavities of the inflow region 8 and/or of the return-flow region 9, the honeycomb body 2 is constructed from metallic layers 22, 23 as shown by way of example in FIG. 3. The metallic layer with holes 27 shown in FIG. 3 is a substantially smooth metallic layer 22. Similarly, it is possible to form an at least partially structured metallic layer 23 with holes 27.

The metallic layer 22 is divided into five regions, as seen in the transverse direction 28 of the honeycomb structure 2. The fact that it is divided into precisely five subregions is based on the fact that holes 27 are to be formed both in the inflow region 8 and in the return-flow region 9 in the present case. Metallic layers 22 having a different number of regions are possible in accordance with the invention. The position, size and shape of the holes 27 shown in FIG. 3 is given by way of example and any other position, size and shape of holes 27 is possible in accordance with the invention. In particular, it is possible for holes 27 of a different shape and size to be formed in one region or to form regions with holes 27 which differ with regard to shape and size.

When the stack is being formed, the metallic layer 22 is folded about a folding axis 29. After the honeycomb structure 2 has been produced, an inner region 30 forms part of the walls of the cavities of the inflow region 8, while intermediate regions 31 are located behind the connector 7 and are therefore used to separate the inflow region 8 from the return-flow region 9. Therefore, the inner region 30 has holes 27, while the intermediate regions 31 do not have any holes.

The intermediate regions 31 are formed in different sizes in order to take into account the relative position of the metallic layer 22 in the honeycomb structure 2. The angle at which the metallic layer 22 intersects the region located behind the connector 7 is crucial to the size of the intermediate regions 31. Various angles are possible, as can be seen from FIG. 2. The shallower this angle of intersection, the larger the size of the corresponding intermediate region 31 has to be in order to ensure that the inflow region 8 is effectively separated from the return-flow region 9. Therefore, with very steep angles, it is possible for the intermediate region 31 to have a small size. Moreover, depending on the position of the metallic layer 22 with respect to the connector 7, it is possible for the centers of the intermediate regions 31 to be at a different distance from the folding axis 29 in each case.

Outer regions 32 which adjoin the intermediate regions 31 in turn have holes 27, since these regions form the walls of the cavities of the return-flow region 9 after the honeycomb structure 2 has been produced. Edge regions 33 do not have any holes, in order to allow them to be securely attached to the tubular casing 3, for example by brazing and/or welding.

The holes 27 may be of any desired shape and size, provided that it is ensured that the size of the holes 27 is larger than the structure repetition length of the structures of the structured metal sheets 23. This creates communicating cavities or passages through which the exhaust gas can flow. It is expedient if no holes 27 are formed at those edges of the metallic layer 22 which lie in the longitudinal direction 34 of the honeycomb structure 2, in order to prevent the metallic layer 22 from flapping and tearing.

With other forms of the honeycomb structure 2, the metallic layers 22, 23 correspondingly have to be provided with holes 27 in order to ensure that only the walls of the cavities of the inflow region 8 and the return-flow region 9 have holes 27 but these regions 8, 9 are effectively separated from one another.

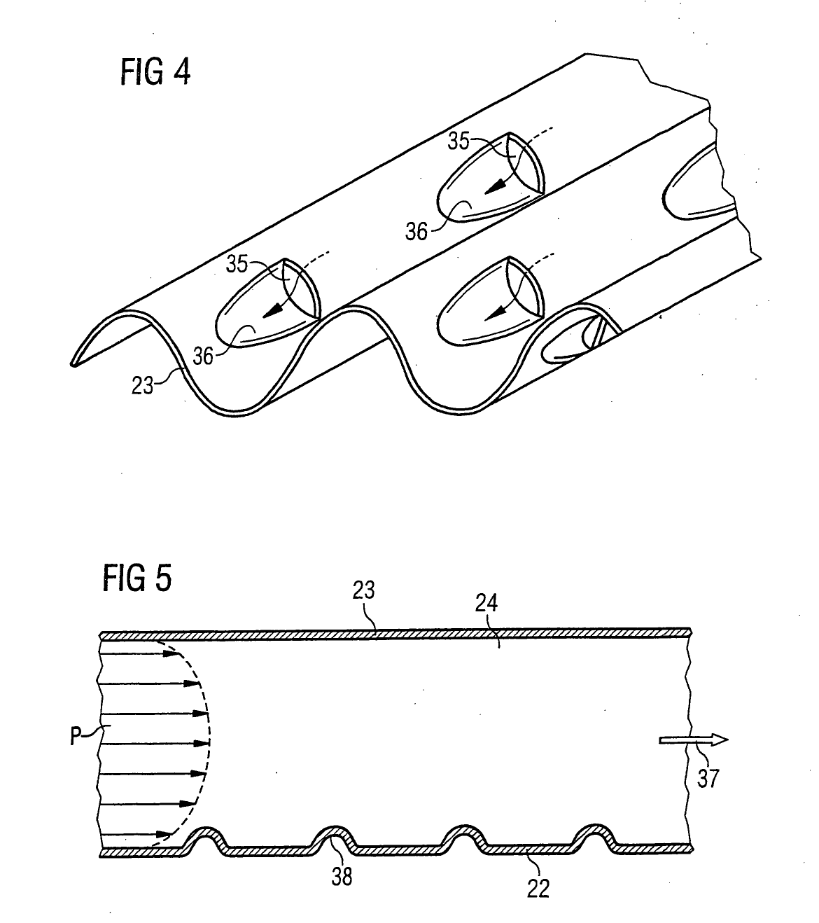

FIG. 4 shows an example of a metallic layer with scoops which can be formed in the outer regions 32 and/or the inner region 30, in the substantially smooth metallic layers 22 and/or the structured metallic layers 23. The scoops include holes 35 and protruding flow-guiding surfaces 36. These scoops substantially have two effects: the holes 35 make it possible to form a cross-flow component, so that the flow in two adjacent cavities of the honeycomb structure 2 is mixed, and in addition the flow-guiding surfaces swirl up the flow in the cavities, in order to prevent laminar interface flows so as to increase the probability of conversion.

Laminar interface flows can also be reduced by the formation of microstructures, as illustrated in FIG. 5. FIG. 5 shows a passage 24 through which exhaust gas flows in a direction of flow 37. Microstructures 38 have been formed. A laminar or quasi-laminar (what is known as plug-flow) flow profile P, in which an interface flow is present, has been formed upstream of the microstructures. In the interface flow, practically only the gas molecules in the outermost edge region come into contact with the surface of the passage 24, and consequently only a relatively low conversion rate is achieved in the exhaust gas as a whole. This conversion rate can be improved if the exhaust gas flows past the microstructures 38 which swirl it up and thereby break up the interface flow.

The statements which have been given above in connection with FIG. 3 relating to the formation of holes 27 in the regions 30, 32 also apply correspondingly to any other type of structural change to which the regions 30, 32 may be subjected. For example, it is equally possible to form regions 30, 32 which, when the honeycomb structure 2 is being constructed, cause the inflow region 8 to be distinguished from the return-flow region 9 by virtue of one or more of the following properties: specific heat capacity, passage number and/or geometry, cavity geometry, coating, type and concentration of catalytically active substances, type and quantity of the formation of scoops, holes 35 of a size which is smaller than the structure repetition length of the at least partially structured metallic layers 23, flow-guiding surfaces 36 and/or microstructures 38 and porosity of the regions. This applies in particular to the relative position of the regions 32 with respect to the folding axis 29, and the size of the regions 30, 32 as seen in the transverse direction 28 of the honeycomb structure 2. The metallic layers 22, 23 may also be formed in such a way that the inflow region 8 and/or the return-flow region 9 are divided in the longitudinal direction 34 into subregions which differ with regard to one or more of the properties given above.

It is advantageous in particular to form an exhaust-gas aftertreatment unit 1 having a honeycomb structure 2 which, in the inflow region 8 works as an oxidation catalytic converter and in the return-flow region 9 works as an open particulate filter, or vice-versa. Specifically, it is possible for the regions 30, 32 which form the walls of the cavities of the inflow region 8 and/or of the return-flow region 9 to be formed from a material which is at least partially permeable to a fluid. An example of a material of this type is a metallic fiber material, in particular sintered metallic fiber material. It is also possible to form a honeycomb structure 2 which at least in part has a higher specific heat capacity in the inflow region 8 than in the return-flow region 9, and vice-versa.

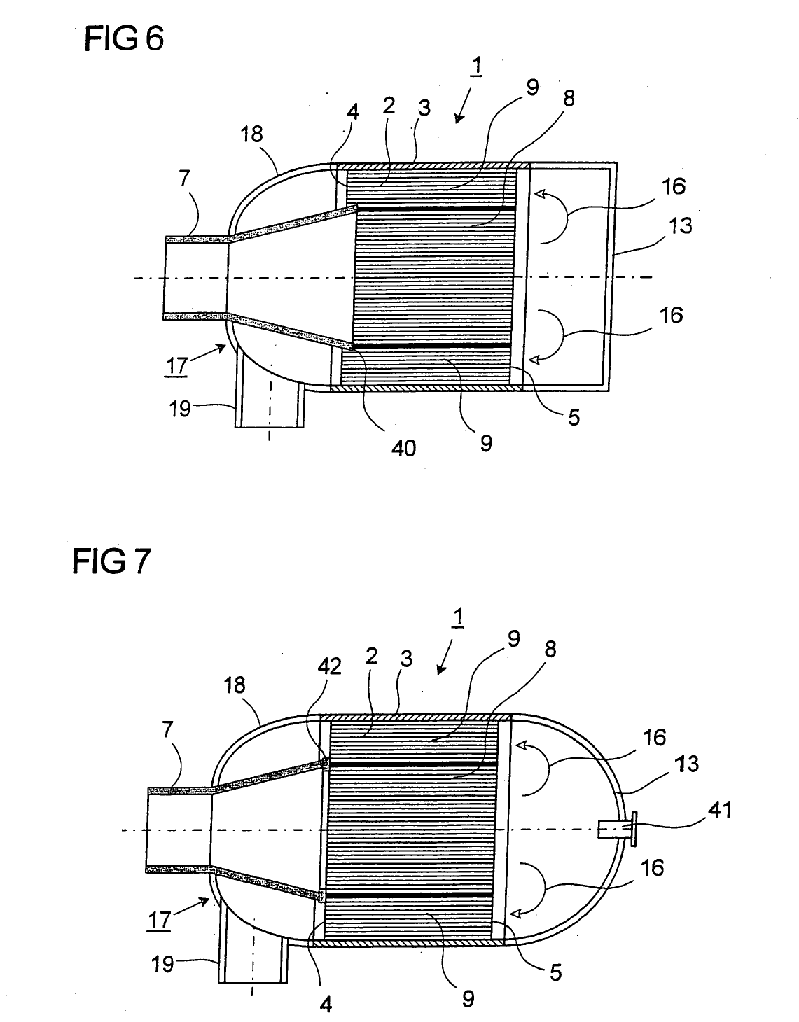

FIG. 6 is a longitudinal-sectional view of a second exemplary embodiment of an exhaust-gas aftertreatment unit 1 according to the invention. The exhaust-gas aftertreatment unit 1 has a honeycomb structure 2 which is held in a tubular casing 3. In the text which follows, i.e. in the description of all of the following exemplary embodiments, in particular with reference to FIGS. 6 to 10, only the differences relative to the first exemplary embodiment will be pointed out. Otherwise, reference is made to the full content of the statements given above in connection with FIGS. 1 to 5.

The second exemplary embodiment includes a flow-inverter 13, which is constructed in the form of a cylinder that is closed on one side. A flow-inverter 13 of this type, as seen in longitudinal section, is in the form of a rectangle which is open on one side. A flow-inverter 13 of this type likewise makes it possible to invert the gas flow in the direction of an arrow 16 from the inflow region 8 into the return-flow region 9 of the honeycomb structure 2. A discharge 17, including a collection space or chamber 18 and an outflow 19, can be produced in the form of a casting. The ability of the discharge 17 to withstand deformation may advantageously be greater than that of the tubular casing 3, for example by forming them from different materials or by forming them with different non-illustrated material thicknesses.

The connector 7 is pressed into the first end face 4 of the honeycomb structure 2 through the use of a pressed-in region 40, so that a substantially sealing connection is formed between the connector 7 and the inflow region 8.

FIG. 7 shows a third exemplary embodiment of an exhaust-gas aftertreatment unit 1 according to the invention, in a longitudinal section. A measurement sensor 41, preferably a lambda sensor and/or a temperature sensor, is formed in the flow-inverter 13, which is hemispherical in shape. A sensitive region of this measurement sensor projects into the region between the flow-inverter 13 and the second end face 5 of the honeycomb structure 2, taking measured values from this volume. It is also possible in accordance with the invention for the measurement sensor 41 to be provided in a differently shaped flow-inverter 13 and for a plurality of measurement sensors 41 to be provided. At least one non-illustrated reagent-feed unit, through which a reagent, for example a reducing agent, such as urea, is introduced into the gas stream during the inversion indicated by the arrow 16, may be provided in the flow-inverter 13, irrespective of the shape of the latter, instead of or in addition to at least one measurement sensor 41. Both the at least one measurement sensor 41 and the at least one reagent-feed unit can engage in the flow-inverter 13 at any desired angle and at any desired position.

The connector 7 is fitted onto the first end face 4 of the honeycomb structure 2. A first seal 42, which advantageously allows an additional seal to be formed between the inflow region 8 and the return-flow region 9, is formed between the connector 7 and the first end face 4. However, a configuration without the first seal 42, i.e. a configuration in which the connector 7 bears directly on the first end face 4, is also possible in accordance with the invention.

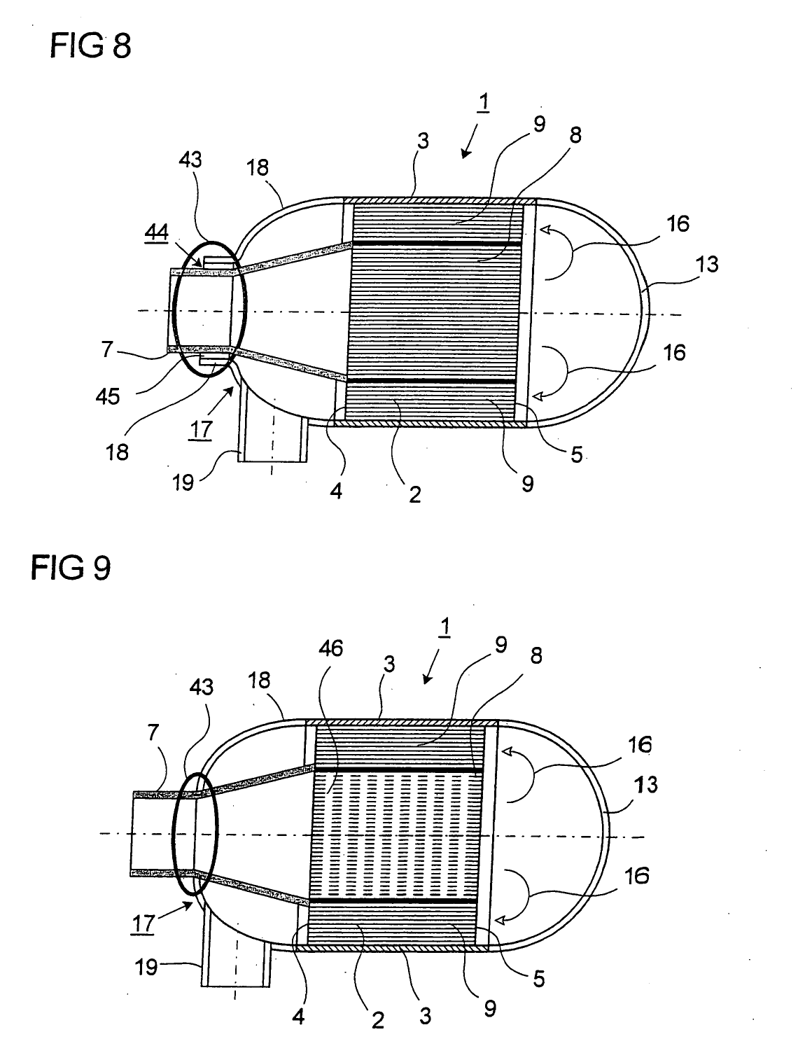

FIG. 8 shows a fourth exemplary embodiment of an exhaust-gas aftertreatment unit 1 according to the invention. FIG. 8 shows a passage region 43 in which the connector 7 passes through the collection space or chamber 18. In this passage region 43, the connector 7 and the collection space or chamber 18 form a sliding or slip seat 44. In addition, there is a second seal 45, which provides an additional sealing effect in order to suppress undesired losses of exhaust gas. However, it is also possible in accordance with the invention for the sliding seat 44 to be provided without the second seal 45. Both the first seal 42 and the second seal 45 are preferably formed from a corrosion-resistant material which is able to withstand high temperatures, for example from a suitable plastic.

Providing the sliding or slip seat 44 in the passage region 43 advantageously compensates for expansions in the event of fluctuating thermal loads when the exhaust-gas aftertreatment unit 1 is operating.

FIG. 9 shows a longitudinal section of a fifth exemplary embodiment of an exhaust-gas aftertreatment unit 1 according to the invention, in which a thermally joined connection, preferably a welded or brazed joint, particularly preferably a welded joint, is formed between the connector 7 and the collection space or chamber 18 in the passage region 43.

Furthermore, the honeycomb structure 2 shown in FIG. 9 has an inhomogeneous configuration, with the honeycomb structure 2 being constructed differently in the inflow region 8 than in the return-flow region 9. As shown and described above by way of example, the honeycomb structure 2 has been constructed from metallic layers, at least some of which are at least partially structured with a structure repetition length and a structuring amplitude. Holes, the dimensions of which are larger than the structure repetition length, are formed in the inflow region 8, so that voids 46, which connect a plurality of cavities or passages in the honeycomb structure 2 to one another, are formed. Voids 46 of this type are not formed in the return-flow region 9. The walls of the return-flow region 9 are formed from a material which is at least partially permeable to a fluid, so that a particulate filter is formed in the return-flow region 9. Other combinations of properties in the inflow region 8 and in the return-flow region 9 are also possible in accordance with the invention. For example, it is possible for all of the measures which have been described herein or in the cited prior art to be provided at least in parts of the regions 8, 9 or combined therein both in the inflow region 8 and in the return-flow region 9. In particular, it is possible for the walls to be formed from material which is at least partially permeable to a fluid, for holes to be formed, in particular with dimensions which are smaller or larger than the structure repetition length, for microstructures, scoops and/or flow-guiding surfaces to be provided, and for coatings having different properties to be provided.

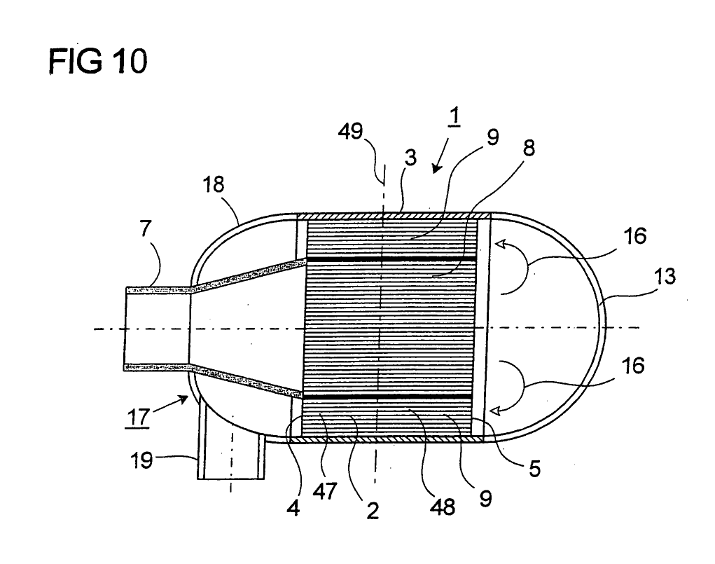

FIG. 10 shows a sixth exemplary embodiment of an exhaust-gas aftertreatment unit 1 according to the invention. The honeycomb structure 2, which is used to construct the exhaust-gas aftertreatment unit 1, has been provided with an inhomogeneous coating. A first axial subregion 47 and a second axial subregion 48, which differ in terms of their coating, have been formed. These subregions 47, 48 are separated by an interface 49. During the coating of the honeycomb structure 2, the latter was coated on one side over the first end face 4 as far as the interface 49 and then on the other side over the second end face 5 as far as the interface 49. In this case, the coatings in the first axial subregion 47 and in the second axial subregion 48 differ, for example in terms of their function, for example by virtue of a hydrocarbon adsorber coating being provided in the second axial subregion 48 and a three-way catalyst coating being provided in the first axial subregion 47, or vice-versa. All other known coatings are also possible in accordance with the invention in each of the subregions 47, 48. A plurality of interfaces 49 and consequently more subregions 47, 48 are also possible in accordance with the invention.

If there are two axial subregions 47, 48, a total of four subregions through which the exhaust gas flows are formed when the exhaust gas flows through the honeycomb structure 2. These regions are firstly the first axial subregion 47 in the inflow region 8, followed by the second axial subregion 48 in the inflow region 8, then the second axial subregion 48 in the return-flow region 9 after inversion in the direction of the arrows 16 by the flow-inverter 13, and finally the first axial subregion 47 in the return-flow region 9. This can in particular also be combined with the inhomogeneity of the walls of the inflow region 8 and/or the return-flow region 9 shown and described in the description relating to FIG. 9.

It is also possible in accordance with the invention for just one of the subregions 47, 48 to be coated.

In the FIG. 11 embodiment, as mentioned above, the outflow 19′ passes through the connector 7′. In this case, a sliding seat 44′ is provided between the outflow 19′ and the connector 7′ in a passage region 43′.

The honeycomb structure 2 shown herein as an exemplary embodiment may, in accordance with the invention, not only have a circular cross section, but may also have any other desired cross section, such as for example an oval, an ellipse, a polygon or the like. This equally applies to the configuration of the cross section of the connector 7, which is connected in a substantially sealing manner to the first end face 4 of the honeycomb structure 2. The details shown, such as for example the structure of the measurement sensor 41, the specific configuration in the passage region 43, the attachment of the connector 7 to the first end face 4, the configuration of the flow-inverter 31, the inhomogeneity of the honeycomb structure 2, the configuration of the coating, if appropriate in a plurality of subregions 47, 48, etc., are possible not only as shown in the corresponding exemplary embodiments, but may also be combined with one another as desired.

An exhaust-gas aftertreatment unit 1 according to the invention advantageously allows aftertreatment of exhaust gases even when there is only a small amount of installation space available. This allows a blind space which is present in the side region of a turbocharger to be used to particularly good effect. An exhaust-gas aftertreatment unit 1 according to the invention can be produced at low cost and is reliable under fluctuating thermal loads, so that a good durability is achieved. It may have different properties and coatings in the inflow region and in the return-flow region, so that it can be adapted to different requirements.

I claim:

1. An exhaust-gas aftertreatment unit, comprising:
a first end face and a second end face;
a tubular casing;
a honeycomb structure through which the exhaust gas can flow, said honeycomb structure being extended between said first end face and said second end face in said tubular casing, said honeycomb structure having an inflow region and a return-flow region;
a connector through which the exhaust gas can flow into said inflow region, said connector being at least substantially sealingly connected to said first end face; and
a flow-inverter behind said second end face, said flow-inverter diverting the exhaust gas from said inflow region into said return-flow region.

2. The exhaust-gas aftertreatment unit according to claim 1, wherein said inflow region and said return-flow region are disposed one inside another.

3. The exhaust-gas aftertreatment unit according to claim 1, wherein said inflow region and said return-flow region are disposed concentrically one inside another.

4. The exhaust-gas aftertreatment unit according to claim 2, wherein said inflow region is disposed inside said return-flow region.

5. The exhaust-gas aftertreatment unit according to claim 2, wherein said return-flow region is disposed inside said inflow region.

6. The exhaust-gas aftertreatment unit according to claim 1, wherein said flow-inverter has a thermal insulation.

7. The exhaust-gas aftertreatment unit according to claim 1, wherein said first end face has a slot formed therein into which said connector projects in a substantially sealing manner.

8. The exhaust-gas aftertreatment unit according to claim 7, wherein said connector and said slot form a sliding seat.

9. The exhaust-gas aftertreatment unit according to claim 7, wherein said connector is pressed into said first end face.

10. The exhaust-gas aftertreatment unit according to claim 1, wherein said connector rests substantially against said first end face.

11. The exhaust-gas aftertreatment unit according to claim 10, which further comprises a first seal formed between said connector and said first end face.

12. The exhaust-gas aftertreatment unit according to claim 1, wherein said connector is a conically widening tube.

13. The exhaust-gas aftertreatment unit according to claim 1, wherein said honeycomb structure is formed of ceramic material.

14. The exhaust-gas aftertreatment unit according to claim 1, wherein said honeycomb structure includes at least one wound metallic layer being at least partially structured.

15. The exhaust-gas aftertreatment unit according to claim 1, wherein said honeycomb structure includes a plurality of wound metallic layers, at least some of said metallic layers being at least partially structured.

16. The exhaust-gas aftertreatment unit according to claim 1, wherein said honeycomb structure includes a plurality of stacked and intertwined metallic layers, at least some of said metallic layers being at least partially structured.

17. The exhaust-gas aftertreatment unit according to claim 14, wherein said inflow region and said return-flow region define cavities, said at least one wound metallic layer has regions forming walls of said cavities and holes formed in at least some of said regions forming said walls of said cavities in at least one of said inflow and return-flow regions.

18. The exhaust-gas aftertreatment unit according to claim 17, wherein said at least one at least partially structured metallic layer has a structure repetition length, and said holes have a size larger than said structure repetition length.

19. The exhaust-gas aftertreatment unit according to claim 15, wherein said inflow region and said return-flow region define cavities, said metallic layers have regions forming walls of said cavities, and at least some of said metallic layers have holes formed in at least some of said regions forming said walls of said cavities in at least one of said inflow and return-flow regions.

20. The exhaust-gas aftertreatment unit according to claim 19, wherein said at least partially structured metallic layers have a structure repetition length, and said holes have a size larger than said structure repetition length.

21. The exhaust-gas aftertreatment unit according to claim 16, wherein said inflow region and said return-flow region define cavities, said metallic layers have regions forming walls of said cavities, and at least some of said metallic layers have holes formed in at least some of said regions forming said walls of said cavities in at least one of said inflow and return-flow regions.

22. The exhaust-gas aftertreatment unit according to claim 21, wherein said at least partially structured metallic layers have a structure repetition length, and said holes have a size larger than said structure repetition length.

23. The exhaust-gas aftertreatment unit according to claim 14, wherein said inflow region and said return-flow region define cavities, said at least one wound metallic layer has regions forming walls of said cavities, and said at least one wound metallic layer is formed of a material at least partially allowing a fluid to flow through it, in at least some of said regions forming said walls of said cavities in at least one of said inflow and return-flow regions.

24. The exhaust-gas aftertreatment unit according to claim 15, wherein said inflow region and said return-flow region define cavities, said metallic layers have regions forming walls of said cavities, and at least some of said metallic layers are formed of a material at least partially allowing a fluid to flow through it, in at least some of said regions forming said walls of said cavities in at least one of said inflow and return-flow regions.

25. The exhaust-gas aftertreatment unit according to claim 16, wherein said inflow region and said return-flow region define cavities, said metallic layers have regions forming walls of said cavities, and at least some of said metallic layers are formed of a material at least partially allowing a fluid to flow through it, in at least some of said regions forming said walls of said cavities in at least one of said inflow and return-flow regions.

26. The exhaust-gas aftertreatment unit according to claim 14, wherein said inflow region and said return-flow region define cavities, said at least one wound metallic layer has regions forming walls of said cavities, said at least one wound metallic layer has a structure repetition length, and said at least one wound metallic layer has at least one of scoops, holes having a size smaller than said structure repetition length, flow-guiding surfaces and microstructures formed in at least some of said regions forming said walls of said cavities in at least one of said inflow and return-flow regions.

27. The exhaust-gas aftertreatment unit according to claim 15, wherein said inflow region and said return-flow region define cavities, said metallic layers have regions forming walls of said cavities, said at least partially structured metallic layers have a structure repetition length, and at least some of said metallic layers have at least one of scoops, holes having a size smaller than said structure repetition length, flow-guiding surfaces and microstructures formed in at least some of said regions forming said walls of said cavities in at least one of said inflow and return-flow regions.

28. The exhaust-gas aftertreatment unit according to claim 16, wherein said inflow region and said return-flow region define cavities, said metallic layers have regions forming walls of said cavities, said at least partially structured metallic layers have a structure repetition length, and at least some of said metallic layers have at least one of scoops, holes having a size smaller than said structure repetition length, flow-guiding surfaces and microstructures formed in at least some of said regions forming said walls of said cavities in at least one of said inflow and return-flow regions.

29. The exhaust-gas aftertreatment unit according to claim 14, wherein said inflow region and said return-flow region define cavities, said at least one wound metallic layer has regions forming walls of said cavities, and said at least one wound metallic layer has a coating in at least some of said regions forming said walls of said cavities in at least one of said inflow and return-flow regions.

30. The exhaust-gas aftertreatment unit according to claim 29, wherein said coating is a catalytically active coating.

31. The exhaust-gas aftertreatment unit according to claim 15, wherein said inflow region and said return-flow region define cavities, said metallic layers have regions forming walls of said cavities, and at least some of said metallic layers have a coating in at least some of said regions forming said walls of said cavities in at least one of said inflow and return-flow regions.

32. The exhaust-gas aftertreatment unit according to claim 31, wherein said coating is a catalytically active coating.

33. The exhaust-gas aftertreatment unit according to claim 16, wherein said inflow region and said return-flow region define cavities, said metallic layers have regions forming walls of said cavities, and at least some of said metallic layers have a coating in at least some of said regions forming said walls of said cavities in at least one of said inflow and return-flow regions.

34. The exhaust-gas aftertreatment unit according to claim 33, wherein said coating is a catalytically active coating.

35. The exhaust-gas aftertreatment unit according to claim 1, wherein said inflow region and said return-flow region have walls, and said walls of at least one of said inflow and return-flow regions have a coating at least in partial regions.

36. The exhaust-gas aftertreatment unit according to claim 35, wherein said coating, at least in one of an inflow direction and a return-flow direction, is inhomogeneous.

37. The exhaust-gas aftertreatment unit according to claim 36, wherein said coating is inhomogeneous with regard to at least one of a presence of said coating, a type of said coating, and different physical and/or chemical effects initiated at, in and/or on said coating.

38. The exhaust-gas aftertreatment unit according to claim 35, wherein:
said honeycomb structure has a plurality of axial subregions; and
said coating in at least one of said inflow and return-flow regions, in at least one of said plurality of axial subregions, is at least one coating selected from the group consisting of:
a) an oxidation catalyst coating;
b) a three-way catalyst coating;
c) an adsorber coating;
d) a nitrogen oxide adsorber coating;
e) a hydrocarbon adsorber coating; and
f) a selective catalytic reduction coating.

39. The exhaust-gas aftertreatment unit according to claim 36, wherein:
said honeycomb structure has a plurality of axial subregions; and
said coating in at least one of said inflow and return-flow regions, in at least one of said plurality of axial subregions, is at least one coating selected from the group consisting of:
a) an oxidation catalyst coating;
b) a three-way catalyst coating;
c) an adsorber coating;
d) a nitrogen oxide adsorber coating;
e) a hydrocarbon adsorber coating; and
f) a selective catalytic reduction coating.

40. The exhaust-gas aftertreatment unit according to claim 14, wherein said inflow region and said return-flow region define cavities, said at least one wound metallic layer has regions forming walls of said cavities, said regions of said at least one wound metallic layer forming said walls of said cavities of said inflow region have a first specific heat capacity, said regions of said at least one wound metallic layer forming said walls of said cavities of said return-flow region have a second specific heat capacity, and said first specific heat capacity is different than said second specific heat capacity in at least some of said metallic layers.

41. The exhaust-gas aftertreatment unit according to claim 15, wherein said inflow region and said return-flow region define cavities, said metallic layers have regions forming walls of said cavities, said regions of said metallic layers forming said walls of said cavities of said inflow region have a first specific heat capacity, said regions of said metallic layers forming said walls of said cavities of said return-flow region have a second specific heat capacity, and said first specific heat capacity is different than said second specific heat capacity in at least some of said metallic layers.

42. The exhaust-gas aftertreatment unit according to claim 16, wherein said inflow region and said return-flow region define cavities, said metallic layers have regions forming walls of said cavities, said regions of said metallic layers forming said walls of said cavities of said inflow region have a first specific heat capacity, said regions of said metallic layers forming said walls of said cavities of said return-flow region have a second specific heat capacity, and said first specific heat capacity is different than said second specific heat capacity in at least some of said metallic layers.

43. The exhaust-gas aftertreatment unit according to claim 14, wherein said inflow region and said return-flow region define cavities, said at least one wound metallic layer has regions forming walls of said cavities, said regions forming said walls of said cavities of said inflow region and said regions forming said walls of said cavities of said return-flow region differ in said at least one wound metallic layer with regard to at least one property selected from the group consisting of:
A) material thickness;
B) configuration, size and thickness of a reinforcing structure; and
C) configuration and composition of a coating.

44. The exhaust-gas aftertreatment unit according to claim 15, wherein said inflow region and said return-flow region define cavities, said metallic layers have regions forming walls of said cavities, said regions forming said walls of said cavities of said inflow region and said regions forming said walls of said cavities of said return-flow region differ in at least some of said metallic layers with regard to at least one property selected from the group consisting of:
A) material thickness;
B) configuration, size and thickness of a reinforcing structure; and
C) configuration and composition of a coating.

45. The exhaust-gas aftertreatment unit according to claim 16, wherein said inflow region and said return-flow region define cavities, said metallic layers have regions forming walls of said cavities, said regions forming said walls of said cavities of said inflow region and said regions forming said walls of said cavities of said return-flow region differ in at least some of said metallic layers with regard to at least one property selected from the group consisting of:
A) material thickness;
B) configuration, size and thickness of a reinforcing structure; and
C) configuration and composition of a coating.

46. The exhaust-gas aftertreatment unit according to claim 14, wherein said inflow region and said return-flow region define cavities, said at least one wound metallic layer has regions forming walls of said cavities, and said regions of said at least one wound metallic layer forming said walls of said cavities of at least one of said inflow and return-flow regions have an inhomogeneous specific heat capacity.

47. The exhaust-gas aftertreatment unit according to claim 15, wherein said inflow region and said return-flow region define cavities, said metallic layers have regions forming walls of said cavities, and said regions of said metallic layers forming said walls of said cavities of at least one of said inflow and return-flow regions have an inhomogeneous specific heat capacity.

48. The exhaust-gas aftertreatment unit according to claim 16, wherein said inflow region and said return-flow region define cavities, said metallic layers have regions forming walls of said cavities, and said regions of said metallic layers forming said walls of said cavities of at least one of said inflow and return-flow regions have an inhomogeneous specific heat capacity.

49. The exhaust-gas aftertreatment unit according to claim 14, wherein:
said inflow region and said return-flow region define cavities;
said at least one wound metallic layer has regions forming walls of said cavities;
said regions of said at least one wound metallic layer forming said walls of said inflow region have a structuring with a first structure repetition length parameter, a first structure height parameter and a first structure shape parameter;
said regions of said at least one wound metallic layer forming said walls of said return-flow region have a structuring with a second structure repetition length parameter, a second structure height parameter and a second structure shape parameter; and
at least one of said first and second parameters are different.

50. The exhaust-gas aftertreatment unit according to claim 15, wherein:
said inflow region and said return-flow region define cavities;
said metallic layers have regions forming walls of said cavities;
said regions of said structured metallic layers forming said walls of said inflow region have a structuring with a first structure repetition length parameter, a first structure height parameter and a first structure shape parameter;
said regions of said structured metallic layers forming said walls of said return-flow region have a structuring with a second structure repetition length parameter, a second structure height parameter and a second structure shape parameter; and
at least one of said first and second parameters are different.

51. The exhaust-gas aftertreatment unit according to claim 16, wherein:
said inflow region and said return-flow region define cavities;
said metallic layers have regions forming walls of said cavities;
said regions of said structured metallic layers forming said walls of said inflow region have a structuring with a first structure repetition length parameter, a first structure height parameter and a first structure shape parameter;
said regions of said structured metallic layers forming said walls of said return-flow region have a structuring with a second structure repetition length parameter, a second structure height parameter and a second structure shape parameter; and
at least one of said first and second parameters are different.

52. The exhaust-gas aftertreatment unit according to claim 1, wherein said flow-inverter disposed behind said second end face of said honeycomb structure inverts a direction of flow of the exhaust gas flowing out of said inflow region into said return-flow region.

53. The exhaust-gas aftertreatment unit according to claim 52, wherein said flow-inverter has a substantially half-shell shape selected from the group consisting of substantially hemispherical, substantially half-spherical cap-shaped and substantially cylindrical with one closed side.

54. The exhaust-gas aftertreatment unit according to claim 53, wherein said flow-inverter has a central indentation.

55. The exhaust-gas aftertreatment unit according to claim 1, which further comprises a collection space disposed at said first end face for collecting the exhaust gas flowing through said return-flow region and emerging through said first end face outside said connector.

56. The exhaust-gas aftertreatment unit according to claim 55, wherein said collection space has a shape selected from the group consisting of substantially spherical cap-shaped, hemispherical and closed half-cylindrical.

57. The exhaust-gas aftertreatment unit according to claim 55, which further comprises an outflow for discharging the exhaust gas flowing through said return-flow region, said outflow being connected to at least one of said collection space or said tubular casing.

58. The exhaust-gas aftertreatment unit according to claim 57, wherein said outflow is gas-tightly connected to at least one of said tubular casing or said collection space.

59. The exhaust-gas aftertreatment unit according to claim 55, wherein said collection space is gas-tightly connected to said tubular casing.

60. The exhaust-gas aftertreatment unit according to claim 55, wherein said connector passes through said collection space in a passage region.

61. The exhaust-gas aftertreatment unit according to claim 57, wherein said outflow passes through said connector in a passage region.

62. The exhaust-gas aftertreatment unit according to claim 60, which further comprises a thermally joined connection between said connector and said collection space.

63. The exhaust-gas aftertreatment unit according to claim 62, wherein said thermally joined connection is a brazed or welded joint in said passage region.

64. The exhaust-gas aftertreatment unit according to claim 61, which further comprises a thermally joined connection between said outflow and said connector.

65. The exhaust-gas aftertreatment unit according to claim 64, wherein said thermally joined connection is a brazed or welded joint in said passage region.

66. The exhaust-gas aftertreatment unit according to claim 60, which further comprises a sliding seat between said connector and said collection space in said passage region.

67. The exhaust-gas aftertreatment unit according to claim 61, which further comprises a sliding seat between said outflow and said connector in said passage region.

68. The exhaust-gas aftertreatment unit according to claim 60, which further comprises a seal between said connector and said collection space in said passage region.

69. The exhaust-gas aftertreatment unit according to claim 61, which further comprises a seal between said outflow and said connector in said passage region.

70. The exhaust-gas aftertreatment unit according to claim 57, wherein at least one of said collection space or said outflow is more resistant to deformation than said tubular casing.

71. The exhaust-gas aftertreatment unit according to claim 57, wherein at least one of said collection space or said outflow has a greater material thickness than, and is more resistant to deformation than, said tubular casing.

72. The exhaust-gas aftertreatment unit according to claim 1, which further comprises at least one measurement sensor.

73. The exhaust-gas aftertreatment unit according to claim 72, wherein said at least one measurement sensor is disposed in said flow-inverter.

74. The exhaust-gas aftertreatment unit according to claim 72, wherein said at least one measurement sensor can record at least one measurement variable selected from the group consisting of:
a) oxygen content of the exhaust gas;
b) temperature of the exhaust gas;
c) level of at least one component in the exhaust gas;
d) flow velocity of the exhaust gas; and
e) volumetric flow density of the exhaust gas.

75. The exhaust-gas aftertreatment unit according to claim 1, which further comprises at least one reagent-feed unit.

76. The exhaust-gas aftertreatment unit according to claim 75, wherein said at least one reagent-feed unit is said flow-inverter.
